(19) United States
(12) Patent Application Publication
(10) Pub. No.: US 2008/0028104 A1
(43) Pub. Date: Jan. 31, 2008

(54) Semiconductor device and operation control method of semiconductor device

(75) Inventor: Kiyoshi Tsuneki, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 11/808,675

(22) Filed: Jun. 12, 2007

(30) Foreign Application Priority Data
Jun. 19, 2006 (JP) 2006-168942

(51) Int. Cl. G06F 3/00

(52) U.S. Cl. 710/1

(57) ABSTRACT

A semiconductor device according to an embodiment of the present invention includes: a first semiconductor chip performing a predetermined operation based on a first control signal or a second control signal; a second semiconductor chip selectively outputting the external first control signal or the internal second control signal; and a line inputting the first or second control signal output from the second semiconductor chip to the first semiconductor chip.

### BACKGROUND OF THE INVENTION

1. Field of the Invention

The present invention relates to a semiconductor device and an operation control method of the semiconductor device. In particular the invention relates to a semiconductor device equipped with a logic chip and a memory chip, and an operation control method of the semiconductor device.

2. Description of Related Art

There have been hitherto known semiconductor devices, for example, an SIP module (System In Package) module that integrates plural semiconductor chips such as a logic chip and a memory chip into one package. Japanese Unexamined Patent Application Publication No. 2004-85366 discloses a technique of testing such a semiconductor device.

In the case of testing the SIP module, each chip should be tested. For example, in the SIP module including a logic chip and a memory chip, it is necessary to supply a control signal that would be transmitted from a logic chip to a memory chip under normal operations, for example, CS (Chip Select) signal from the outside of the SIP module upon testing a memory chip alone.

This is because, if the CS signal is transmitted from the logic chip upon testing the memory chip alone, and an abnormality is detected during testing, it is uncertain whether the abnormality is involved in the memory chip itself or in the logic chip function of generating and transmitting the CS signal.

To that end, a terminal (CS input terminal) of the memory chip for inputting the CS signal is connected to an external terminal of the SIP module. In this way, the CS signal can be input to the memory chip from the outside of the SIP module upon testing the memory chip.

Likewise, a terminal (CS output terminal) of the logic chip for outputting the CS signal is connected to an external terminal of the SIP module for testing the logic chip.

Here, the external terminal connected to the CS input terminal of the memory chip is different from the external terminal of the CS output terminal of the logic chip. If the same terminal is used, short-circuiting occurs between the CS input terminal and the CS output terminal during testing. Then, if an unintended CS signal is output from the logic chip upon testing the memory chip alone, testing cannot be normally carried out.

The inventors of the subject application have found the following problems in the related art. Under normal operations, the CS signal should be transmitted from the logic chip to the memory chip. Therefore, the external terminal connected to the CS input terminal and the external terminal connected to the CS output terminal are short-circuited on a substrate where the SIP module is mounted, so a designer of such substrate needs to design the substrate with this point in view.

### SUMMARY

In one embodiment of the present invention, there is provided a semiconductor device that includes a first semiconductor chip performing a predetermined operation based on a first control signal or a second control signal, a second semiconductor chip selectively outputting the external first control signal or the internal second control signal, and a line inputting the first or second control signal output from the second semiconductor chip to the first semiconductor chip.

With the semiconductor device of the present invention, the device includes a line for inputting a first or second control signal to a first semiconductor chip in an SIP module, making it unnecessary to short-circuit an external terminal connected with a CS input terminal and an external terminal connected with a CS output terminal on a substrate where the SIP module is mounted.

In another embodiment of the present invention, there is provided a semiconductor chip that the first control signal is output to a predetermined terminal if the first control signal is externally supplied, and the internal second control signal is output to the predetermined terminal if the first control signal is not externally supplied.

With the semiconductor chip of the present invention, under normal operations, a second control signal generated in the semiconductor chip can be output to a and an externally supplied first control signal can be output to the predetermined terminal upon testing.

Further, in another embodiment of the present invention, there is provided an operation control method of a semiconductor device including a first semiconductor chip and a second semiconductor chip, includes: outputting a first control signal to a predetermined terminal with the second semiconductor chip if the first control signal is externally supplied; outputting a second control signal generated in the second semiconductor chip to the predetermined terminal with the second semiconductor chip if the first control signal is not externally supplied; and inputting the first or second control signal output to the predetermined terminal to the first semiconductor chip.

With the operation control method of a semiconductor device of the present invention, under normal operations, a second control signal generated in the semiconductor chip can be output to a predetermined terminal, and an externally supplied first control signal can be output to the predetermined terminal upon testing. Further, under normal operations or upon testing, a first or second control signal input to control the first semiconductor chip can be controlled.

Further, in another embodiment of the present invention, there is provided a semiconductor device that includes a first external terminal, a first semiconductor chip including a first terminal electrically connected with the first external terminal and a second terminal selecting a first control signal input to the first terminal or an internal second control signal to output the selected signal, and a second semiconductor chip including a third terminal electrically connected with the second terminal, and controlled in response to the first control signal and the second control signal.

With the semiconductor device of the present invention, under normal operations, a second control signal generated in the semiconductor chip can be output to a predetermined terminal, and an externally supplied first control signal can be output to the predetermined terminal upon testing. Further, under normal operations or upon testing, a first or second control signal input to control the second semiconductor chip can be controlled by the third terminal of the second semiconductor chip.

With the present invention, under normal operations or upon testing, it is unnecessary to connect between external terminals of the semiconductor device on a substrate where a semiconductor device is mounted.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram of a semiconductor device according to a first embodiment of the present invention;

FIG. 2 is a block diagram of the semiconductor device of the first embodiment;

FIG. 3 is a block diagram of the semiconductor device of the first embodiment; and

FIG. 4 shows a semiconductor device of the related art.

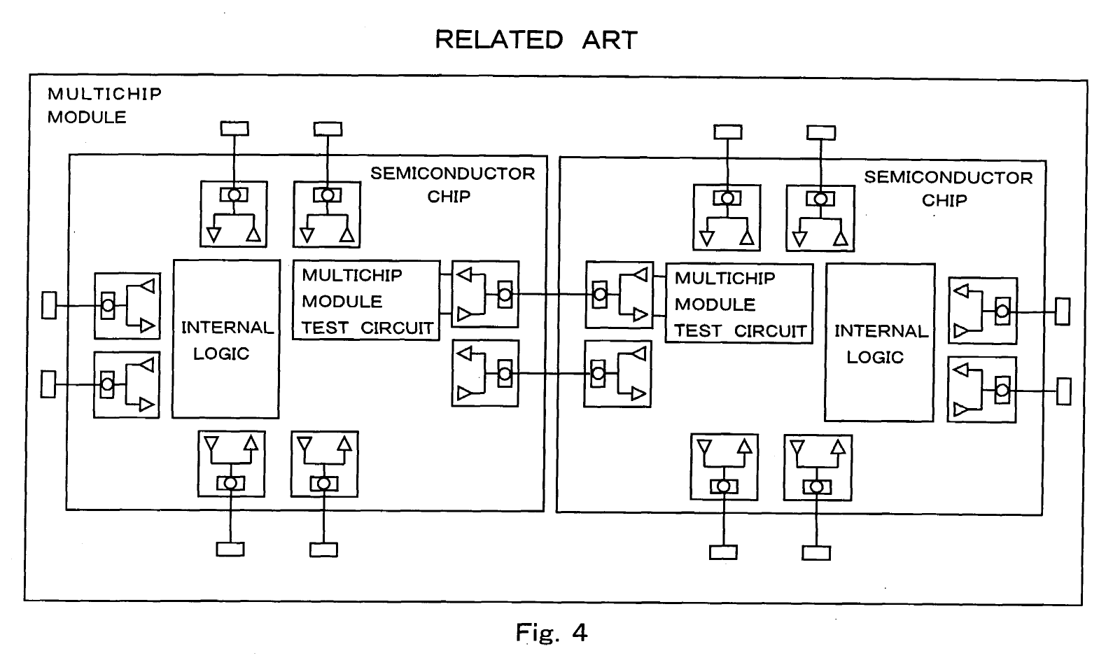

### DETAILED DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

### First Embodiment

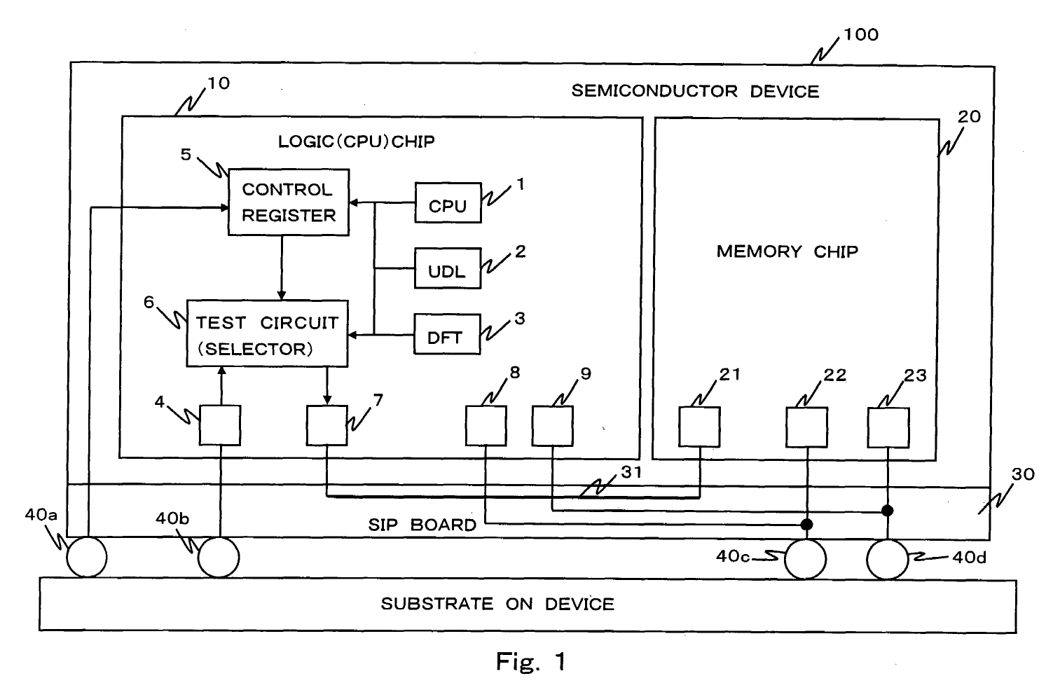

Hereinafter, embodiments of the present invention are described below. FIG. 1 is a block diagram of a semiconductor device 100 according to the present invention. As shown in FIG. 1, the semiconductor device of the first embodiment is an SIP module where plural chips are integrated to a package. The semiconductor device 100 of FIG. 1 includes a logic chip (second semiconductor chip) 10, a memory chip (first semiconductor chip) 20, and an SIP board 30.

The logic chip 10 is a chip for executing computations and programs. In this embodiment, the logic chip outputs a control signal to the memory chip 20 under normal operations of the semiconductor device 100. Schematic configuration of the logic chip 10 is described below. Further, the logic chip 10 includes an address terminal 9 for outputting an address signal to the memory chip 20 or a data terminal 8 for inputting/outputting data to/from the memory chip 20.

The memory chip 20 is a storage cell capable of storing a part of data and programs necessary for normal operations. In this embodiment, the memory chip 20 operates in accordance with a control signal supplied from the outside of the semiconductor device 100 under test operation and operates in accordance with a control signal generated in the semiconductor device 100 (for example, logic chip 10) under normal operations. Further, the memory chip 20 is equipped with an address terminal 23 for receiving an address signal from the logic chip 10 and a data terminal 22 for transmitting/receiving a data signal between the logic chip 10 and the memory chip 20 at the time of writing/reading data to/from the memory chip. In the case of testing the memory chip, the data terminal 22 or the address terminal 23 is connected to an such as a ball electrode or other such external terminals to thereby directly and externally supply a data signal or address signal.

The SIP board 30 is a board where plural semiconductor chips of the semiconductor device (SIP module) 100 are integrated. The SIP board 30 is, for example, a BGA (Ball Grid Array) substrate including a ball electrode 40 for inputting/outputting signals to/from the outside of the semiconductor device 100 and an internal line connecting between terminals of the chips.

In this embodiment, the logic chip 10 includes a CPU (Central Processing Unit) 1, a UDL circuit (User Defined Logic; hereinafter referred to as “UDL”) 2, a DFT circuit (Design For Test; hereinafter referred to as “DFT”) 3, a control signal input terminal 4, a control register 5, a test circuit 6, and a control signal output terminal 7.

In this embodiment, a control signal is input to the control register 5 from a second external terminal (hereinafter referred to as “ball electrode 40a”) or the CPU 1. The control register 5 controls the test circuit 6 in response to the input control signal. The test circuit 6 is composed of, for example, a selector and the like, and selects a control signal input to the control signal input terminal 4 or a control signal generated with the internal circuit such as the CPU 1 or DFT 3 based on a control signal from the control register 5 to send the selected one to a second terminal (hereinafter referred to as “control signal output terminal 7”).

In this embodiment, if a control signal is externally supplied to a first terminal (hereinafter referred to as “control signal input terminal 4”), for example, the test circuit 6 selects the control signal input to the control signal input terminal 4 and outputs the selected one to the control signal output terminal 7. If no control signal is externally supplied, the test circuit 6 outputs a control signal generated with the internal circuit to the control signal output terminal 7. Incidentally, in the configuration of this embodiment, the control register 5 controls the test circuit 6 to flexibly control various paths such as a path for outputting a control signal generated with the CPU 1 or the DFT 3 to the control signal output terminal 7. However, the test circuit 6 itself may function as the control register 5 if the test circuit only needs to choose between an external control signal and an internal control signal based on whether or not a signal is input to the control signal input terminal 4.

In this embodiment, the CPU 1 is a processing unit that executes computations and various kinds of control, and the UDL 2 executes functions unique to each chip. Further, the DFT 3 utilizes the function of the logic chip 10 to generate and output a test pattern or the like.

Further, the memory chip 20 of this embodiment is equipped with a third terminal (hereinafter referred to as “memory control input terminal 21”) which receives a signal for controlling the memory chip 20. The memory control input terminal 21 is connected with the aforementioned control signal output terminal 7 through a line 31 (for example, internal line of the BGA substrate) laid in the semiconductor device 100.

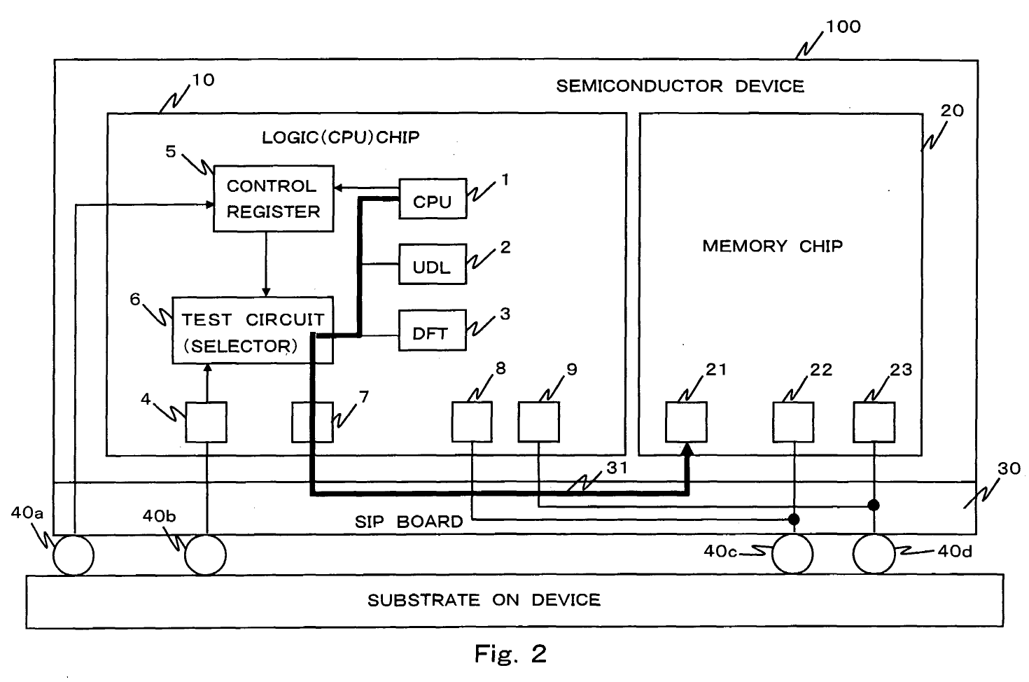

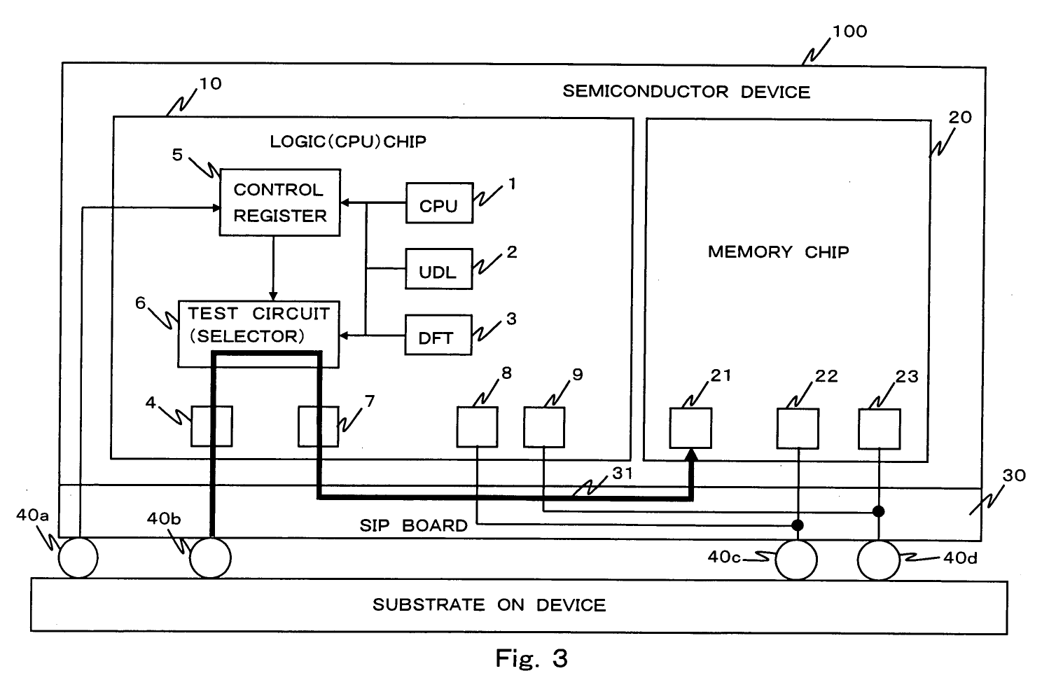

In the semiconductor device thus configured, the control signal output terminal 7, the memory control input terminal 21, and the line 31 are sealed in the package. Thus, external units cannot directly access the control signal output terminal 7 and the memory control input terminal 21. Referring to FIGS. 2 and 3, normal operations and test operations are described in detail below based on the logic chip 10, the memory chip 20, and the SIP board 30.

Under normal operations, the logic chip 10 executes computations on data stored in the memory chip 20 or executes programs stored therein. At this time, the logic chip 10 designates an address of the memory to read data stored at the designated address to thereby carry out various types of processing. The memory chip 20 retrieves data stored at the address designated by the logic chip 10 or writes data to the designated address. Thus, the logic chip 10 outputs signals such as a CS (Chip Select) signal, a CLK (clock) signal, and a WE (Write Enable) signal to the memory chip 20. Incidentally, this embodiment describes the case of outputting a CS signal as a control signal from the logic chip 10 to the memory chip 20.

FIG. 2 shows a path of the CS signal under normal operations. Under normal operations, the CPU 1 outputs a CS signal to the test circuit 6. Further, the CPU 1 outputs a mode selection signal for controlling the test circuit to the control register 5. At this time, the control register 5 outputs a selector control signal to the test circuit 6 based on the mode selection signal sent from the CPU 1. Under normal operations, the test circuit 6 outputs the CS signal generated with the CPU 1 to the control signal output terminal 7 based on the selector control signal output from the control register 5.

The CS signal output to the control signal output terminal 7 is input to the memory control input terminal 21 through the internal line 31 of the SIP board. When the CS signal output from the CPU 1 is input to the memory control input terminal 21, the logic chip 10 outputs an address signal for designating an address in the memory chip 20 to the memory chip 20. After that, the logic chip 10 reads data stored at the designated address to execute various kinds of processing.

As described above, the CS signal output from the CPU 1 is input to the memory control input terminal 21 through the internal line 31 of the SIP board. In this way, the memory control input terminal 21 and the control signal output terminal 7 are connected together through the line 31 (for example, internal line of the BGA substrate) laid in the semiconductor device 100. Therefore, it is unnecessary to carry out wiring on a device substrate (for example, printed board), and the device substrate can be designed without rigid constraints. Further, it is possible to dispense with a ball electrode for inputting/outputting signals between each semiconductor chip and the device substrate (for example, printed board).

Further, in this embodiment, a line for outputting a CS signal from the logic chip 10 to the memory chip 20 is formed in the SIP board 30. However, the line may be laid anywhere in the semiconductor device of the SIP module; for example, the line may directly connect between the logic chip 10 and the memory chip 20.

Next, a method of inputting a CS signal during testing is described. The test is carried out to check whether or not a semiconductor chip operates normally in each step of a manufacturing process. Then, various types of tests such as an operational test of a semiconductor chip alone or a test of connection status between plural semiconductor chips are performed in accordance with a size or integration degree of the semiconductor chip. This embodiment describes the test of a memory chip alone.

FIG. 3 shows a path for a CS signal upon testing the memory chip 20. The CS signal is supplied from a first external terminal (hereinafter referred to as “ball electrode 40b”) to the test circuit 6 through the control signal input terminal 4 in the logic chip 10. In this case, the control register 5 outputs a selector control signal to the test circuit 6 based on the mode selection signal from the CPU 1. At the time of testing the chip, the test circuit 6 outputs an externally supplied CS signal to the control signal output terminal 7 based on the selector control signal sent from the control register 5. The CS signal output to the control signal output terminal 7 is input to the memory control input terminal 21 through the internal line 31 of the SIP board.

When the CS signal output from the control signal output terminal 7 is input to the memory control input terminal 21, the ball electrode 40d sends an address signal to the address terminal 23. Further, the ball electrode 40c sends a test pattern to the data terminal 22 to execute testing. In this case, an impedance level of the data terminal 8 of the logic chip 10 is set high under control. Thus, the test pattern input to the logic chip 10 is cancelled.

Further, in the semiconductor device of this embodiment, the DFT 3 in the logic chip 10 may generate a test pattern and output the generated pattern to the memory chip 20 to perform testing. In this case, a test mode setting signal is sent from an external terminal such as the ball electrode to the CPU 1 or DFT 3. At this time, a signal corresponding to the set test mode is output to the control register 5, and the control register 5 sets a path for outputting a CS signal to the test circuit (selector).

Based on the set path, the CPU 1 or DFT 3 of the test circuit 6 outputs a CS signal to the memory control input terminal 21. When a CS signal is input to the memory control input terminal 21, for example, the DFT 3 outputs a data signal and an address signal to the memory chip 20. In this way, the DFT 3 for generating a test pattern or the like is used based on a function of the logic chip 10, making it possible to test the memory chip 20 in consideration of the function of the logic chip 10.

As described above, a CS signal output from the ball electrode 40b is input to the memory control input terminal 21 through the test circuit 6 in the logic chip 10 and the internal line 31 of the SIP board. In this way, the memory control input terminal 21 and the control signal output terminal 7 are connected together through the line 31 formed in the semiconductor device 100 (for example, through the internal line of the BGA substrate). Hence, it is unnecessary to form a line on a device substrate (for example, printed board), and the device substrate can be designed without rigid constraints. Further, it is possible to dispense with a ball electrode for inputting/outputting signals between each semiconductor chip and the device substrate (for example, printed board).

Further, in this embodiment, at the time of testing a memory chip alone, a line for outputting a CS signal to the memory chip 20 from a ball electrode through the logic chip 10 is formed in the SIP board 30. However, the line can be formed anywhere in the semiconductor device constituting the SIP module; for example, the line can directly connect between the logic chip 10 and the memory chip 20.

As described above, under normal operations, a CS signal output from the CPU 1 is input to the memory control input terminal 21 through the internal line 31 of the SIP board. Further, upon testing the memory, a CS signal output from the external terminal such as the ball electrode is input to the memory control input terminal 21 through the test circuit 6 in the logic chip 10 and the internal line 31 of the SIP board. When a CS signal is input to the memory control input terminal 21, normal operations or various operations such as a test operation are performed. That is, under normal operations or upon testing the memory, a CS signal input to control the memory chip can be controlled by one memory control input terminal 21.

According to the present invention, under normal operations or upon testing a semiconductor chip alone, it is unnecessary to form a line for inputting a control signal on a device substrate (for example, printed board). Further, it is possible to dispense with a ball electrode for inputting/outputting signals between each semiconductor chip and the device substrate (for example, printed board). Further, a line length can be reduced by wiring plural semiconductor chips in the SIP module device, so an influence of noise can be suppressed.

The present invention is described in detail based on the embodiments up to here, but various modifications of the present invention can be made within the scope of the invention. Further, in the above embodiments, the first semiconductor chip is a memory chip and the second semiconductor chip is a logic chip, but a desired chip can be selected from plural semiconductor chips in the SIP module as the first semiconductor chip and the second semiconductor chip, and a first semiconductor chip and second semiconductor chip specified in the scope of claims are not a logic chip and a memory chip, respectively.

It is apparent that the present invention is not limited to the above embodiment but may be modified and changed without departing from the scope and spirit of the invention.

What is claimed is:

1. A semiconductor device, comprising:
a first semiconductor chip performing a predetermined operation based on a first control signal or a second control signal;
a second semiconductor chip selectively outputting the external first control signal or the internal second control signal; and
a line inputting the first or second control signal output from the second semiconductor chip to the first semiconductor chip.

2. The semiconductor device according to claim 1, wherein the second semiconductor chip outputs the first control signal to a predetermined terminal if the first control signal is externally supplied, and outputs the internal second control signal to the predetermined terminal if the first control signal is not externally supplied.

3. The semiconductor device according to claim 1, wherein the second semiconductor chip includes:
a selector selecting a path for outputting the first control signal or a path for outputting the second control signal; and
a control register determining a path selected by the selector.

4. A semiconductor chip comprising:
selector outputting a first control signal to a predetermined terminal if the first control signal is externally supplied, and outputting an internal second control signal to the predetermined terminal if the first control signal is not externally supplied.

5. The semiconductor chip according to claim 4, wherein a selector selecting a path for outputting the first control signal or a path for outputting the second control signal is provided.

6. The semiconductor chip according to claim 4, wherein a control register determining a path selected by the selector is provided.

7. An operation control method of a semiconductor device including a first semiconductor chip and a second semiconductor chip, comprising:
outputting a first control signal to a predetermined terminal with the second semiconductor chip if the first control signal is externally supplied;
outputting a second control signal generated in the second semiconductor chip to the predetermined terminal with the second semiconductor chip if the first control signal is not externally supplied; and
inputting the first or second control signal output to the predetermined terminal to the first semiconductor chip.

8. A semiconductor device, comprising:
a first external terminal;
a first semiconductor chip including a first terminal electrically connected with the first external terminal and a second terminal selecting a first control signal input to the first terminal or an internal second control signal to output the selected signal; and
a second semiconductor chip including a third terminal electrically connected with the second terminal, and controlled in response to the first control signal and the second control signal.

9. The semiconductor device according to claim 8, wherein the first semiconductor chip includes a selector circuit selecting one of the first and second control signals to output the selected signal to the second terminal.

10. The semiconductor device according to claim 9, wherein the selector circuit includes a register determining whether to select the first control signal or the second control signal.

11. The semiconductor device according to claim 10, further comprising:
a second external terminal,
wherein a signal input from the second external terminal is written to the register.

12. The semiconductor device according to claim 8, wherein the second terminal and the third terminal cannot be directly accessed from the outside.

13. The semiconductor device according to claim 8, wherein the second terminal, the third terminal, and a line connecting the second and third terminals are sealed.

14. The semiconductor device according to claim 8, wherein the first semiconductor chip is a logic chip, and the second semiconductor chip is a memory chip.

15. The semiconductor device according to claim 8, wherein the third terminal is a terminal to input a chip select signal.
